(19) United States
(12) Patent Application Publication
(10) Pub. No.: US 2016/0077422 A1
(43) Pub. Date: Mar. 17, 2016

(54) COLLABORATIVE SYNCHRONIZED MULTI-DEVICE PHOTOGRAPHY

(71) Applicant: Adobe Systems Incorporated, San Jose, CA (US)

(72) Inventors: Jue Wang, Kenmore, WA (US); Yan Wang, New York, NY (US); Sunghyun Cho, Yuseong-gu (KR)

(73) Assignee: ADOBE SYSTEMS INCORPORATED, San Jose, CA (US)

(21) Appl. No.: 14/484,939

(22) Filed: Sep. 12, 2014

(51) Int. Cl. G03B 37/04; H04N 5/232; H04N 9/09

(52) U.S. Cl. CPC G03B 37/04; H04N 9/09; H04N 5/23238; H04N 5/23222; H04N 5/23293; G03B 2205/00

(57) ABSTRACT

Techniques are disclosed for collaborative and synchronized photography across multiple digital camera devices. A panoramic photograph of a scene can be generated from separate photographs taken by each of the cameras simultaneously. During composition, the viewfinder images from each camera are collected and stitched together on the fly to create a panoramic preview image. The panoramic preview is then displayed on the camera devices as live visual guidance, which each user can use to change the orientation of the camera and thus change the composition of the panoramic photograph. In some cases, the host sends visual instructions to other camera devices to guide users in camera adjustment. When the desired composition is achieved, the host sends a trigger command to all of the cameras to take photographs simultaneously. Each of these separate photographs can then be stitched together to form a panoramic photograph.

### FIELD OF THE DISCLOSURE

This disclosure relates to the field of data processing, and more particularly, to techniques for collaborative and synchronized photography across multiple users and devices.

### BACKGROUND

Photography has been largely a single person task since the invention of the camera in the 18th century. Cameras are designed for use by one photographer who controls all the key factors in taking a photograph, from scene composition to activating the camera shutter. Despite improvements to various aspects of camera design (e.g., the evolution from film to digital photography), the basic workflow of taking a picture using a single camera controlled by one photographer has remained unchanged.

### BRIEF DESCRIPTION OF THE DRAWINGS

The accompanying drawings are not intended to be drawn to scale. In the drawings, each identical or nearly identical component that is illustrated in various figures is represented by a like numeral.

FIG. 1 illustrates an example system for synchronized photography, in accordance with an embodiment of the present invention.

FIG. 2 is an example data flow diagram for the example system of FIG. 1, in accordance with an embodiment of the present invention.

FIG. 3 shows an example representation of three mobile devices configured for synchronized photography, in accordance with an embodiment of the present invention.

FIGS. 4A and 4B show example user interfaces of two of the devices of FIG. 3, in accordance with some embodiments of the present invention.

FIG. 5 is a flow diagram of an example methodology for synchronized photography, in accordance with an embodiment of the present invention.

FIG. 6 is a flow diagram of another example methodology for synchronized photography, in accordance with an embodiment of the present invention.

FIG. 7 is a block diagram representing an example computing system that may be used in accordance with an embodiment of the present invention.

### DETAILED DESCRIPTION

As mentioned above, a camera is designed for use by one photographer. However, a single camera cannot satisfy all the creative needs that a consumer may have. For example, existing techniques for creating a panoramic photograph involve taking multiple shots at different angles with the same camera and stitching those images together along common image boundaries. Even if taken in rapid succession, each of the shots occurs at different points in time. As such, existing techniques do not work well for a variety of situations, including highly dynamic scenes that contain fast moving objects such as pedestrians or cars, which can easily lead to severe ghosting artifacts due to their fast motion during the image capturing process. To avoid such artifacts, all photos covering different parts of the scene may be taken at exactly the same time by several cameras. However, controlling several cameras in this manner is beyond the capability of existing consumer cameras and typically requires the use of specialized professional equipment.

To this end, and in accordance with an embodiment of the present invention, techniques are disclosed for collaborative and synchronized photography across multiple digital camera devices, such as those found in consumer electronics (e.g., smart phones, tablet computers, and the like). A panoramic photograph of a scene can be generated from separate photographs taken by each of the cameras. Each of the photographs is captured simultaneously, which reduces or eliminates artifacts and other undesirable effects of acquiring separate images at different times in a dynamic environment where objects in the scene are moving or changing form. To coordinate composition of the panoramic photograph and achieve synchronized image capture, one of the cameras in the group is designated as a host. During composition, the users point their cameras toward different portions of the scene. The viewfinder images from each camera are collected and stitched together on the fly in real-time or near real-time to create a panoramic preview image. The panoramic preview is then displayed on one or more of the camera devices as live visual guidance so the respective users can see the composition of the panoramic photograph prior to taking the photographs. Using the panoramic preview as guidance, each user can change the orientation of the camera, thus changing the composition of the panoramic photograph. In some cases, the host sends visual aiming instructions to other camera devices to guide users in camera adjustment, although the users may make adjustments without such instructions. When the desired composition is achieved, the host sends a trigger command to all of the cameras to take photographs simultaneously. Each of these separate photographs can then be stitched together to form a panoramic photograph. In this manner, multiple users can work together to capture high quality panoramas of dynamic scenes, which cannot be achieved with existing single camera panorama capturing techniques. Numerous configurations and variations will be apparent in light of this disclosure.

As used in this disclosure, the term “panoramic” refers to a photographic image with an elongated or wide-angle field of view. In some embodiments, a panoramic photograph can be generated by combining several separate photographs having overlapping fields of view into a single image.

As used in this disclosure, the term “stitching” refers to a process of combining, by a computer, several separate digital images having overlapping fields of view into a single digital image. Such a stitching process can include matching one or more features in the overlapping fields of view and using those features to align the separate images with respect to those features.

In an example embodiment, one of several camera devices is designated as the host of a group of several cameras operated by different users. The group can be formed by displaying a barcode or other machine-readable code on the host (e.g., the first camera device joining the group) and causing each of the other camera devices to scan and process the barcode. Management and coordination of the cameras in the group can be facilitated by a central server system, which may be a separate device connected to each camera via a wired or wireless communication network. The server collects all viewfinder images from the cameras, analyzes their content to discover the relative camera positions, and stitches the viewfinder images together on the fly to generate a live panorama preview image. The live preview image is streamed to one or more of the camera devices in the group and displayed to the users via a user interface (UI). Thus, on the UI each user can view the contribution of the respective camera to the scene composition, as well as view the scene coverage of the other cameras in the group. Guided by the visualization, the user can move the camera relative to other cameras in the group to increase the scene coverage of the panorama and avoid gaps and holes in the panoramic scene. In addition to displaying the preview image, the UI allows the host to send visual aiming instructions to the users of the other cameras by applying swipe-like or other touch contact input gestures (e.g., tap, drag, flick, etc.) to the UI for coordinating the adjustment of each camera. Once all of the cameras have been adjusted, the host sends a shutter trigger request to the server, which in turn commands each camera to activate the camera shutter function for acquiring an image. In this manner, the images acquired by each camera can be stitched together to form a panoramic photograph in which each region of the scene is photographed simultaneously or nearly simultaneously.

Example System

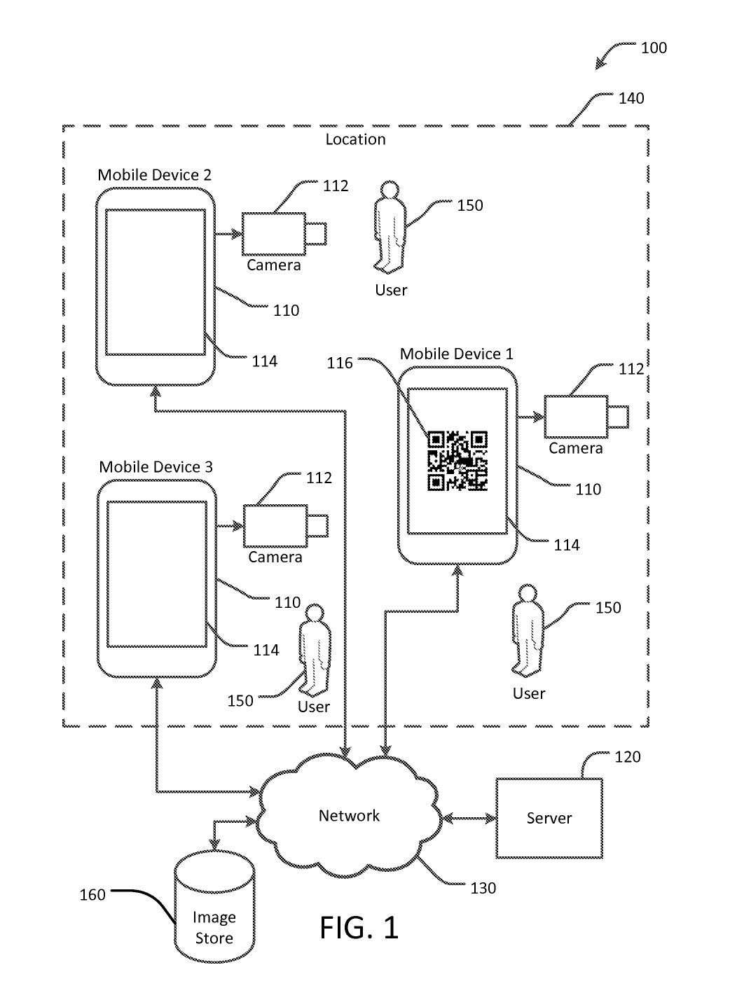

FIG. 1 shows an example system 100 for synchronized photography, in accordance with an embodiment of the present invention. The system includes one or more mobile devices 110 and a server 120 that communicates via a communication network 130 with each mobile device 110. Each mobile device 110 has a camera 112 and a display 114. Generally, the device 110 can include any type of computing device, such as a laptop personal computer (PC), tablet, or smart phone. It will be understood that the camera 110 and display 114 can be integrated into a single device or into several devices (e.g., the camera 110 may be a separate Universal Serial Bus (USB) camera connected to the device 110, or the display 114 may be a standalone computer monitor connected to the computing device 110). In some embodiments, the display 114 includes a touch-sensitive screen that is configured to detect a contact between a user's finger or a stylus and the surface of the screen, and the location and movement of such screen contact. The display 114 can display images from the camera 112 and a barcode 116 (e.g., a QR or Quick Response code) or other machine-readable code. The server 120 can communicate with each mobile device 110 using standard HTTP protocols or other suitable communication protocols. The network 130 or portions of the network can include a high bandwidth communication network, such as WiFi® or 4G, and can be interconnected with the Internet or an intranet. The system 100 allows users 150 who are physically at a common location 140 to dynamically and temporally form a team for photographing a scene. This flexible setup allows unrelated users to work together as a team.

By way of example, each device 110 can be configured to obtain a plurality of images and send the images to the server 120. The server 120 in turn can send one or more of the images to the display 114 of each device so that each user can view the images. Additionally or alternatively, the server 120 can send one or more of the images to an image store 160 or other suitable memory for storage and subsequent retrieval. The image store 160 may be an internal memory of the device 110 or server 120, or an external database (e.g., a server-based database) accessible via a wired or wireless communication network, such as the Internet.

Example Data Flow

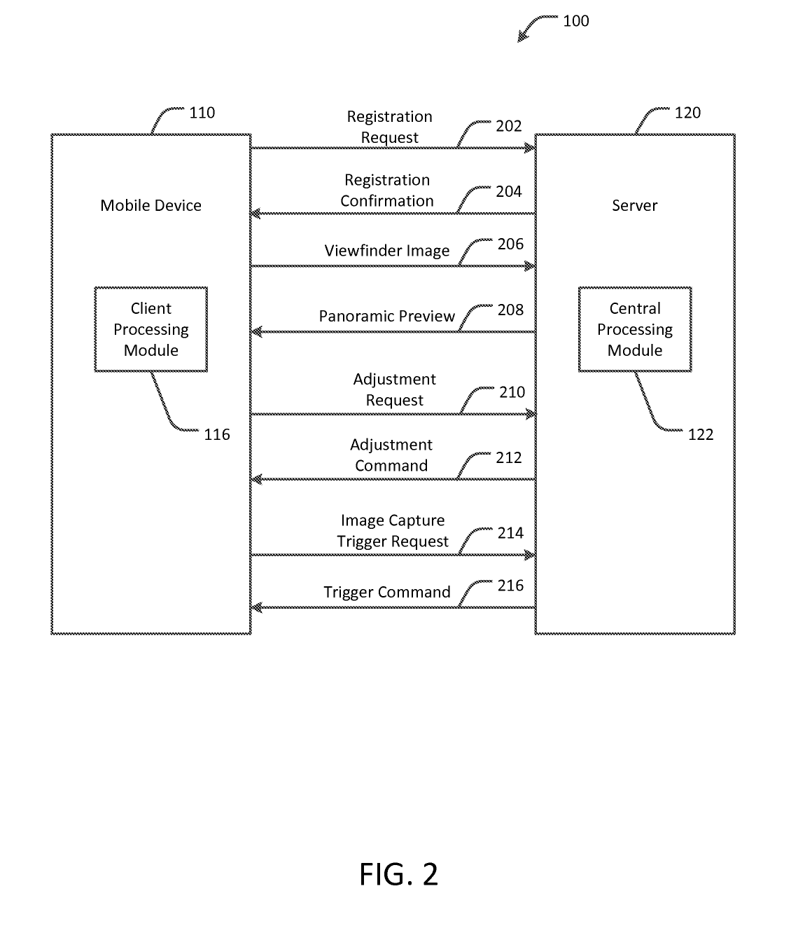

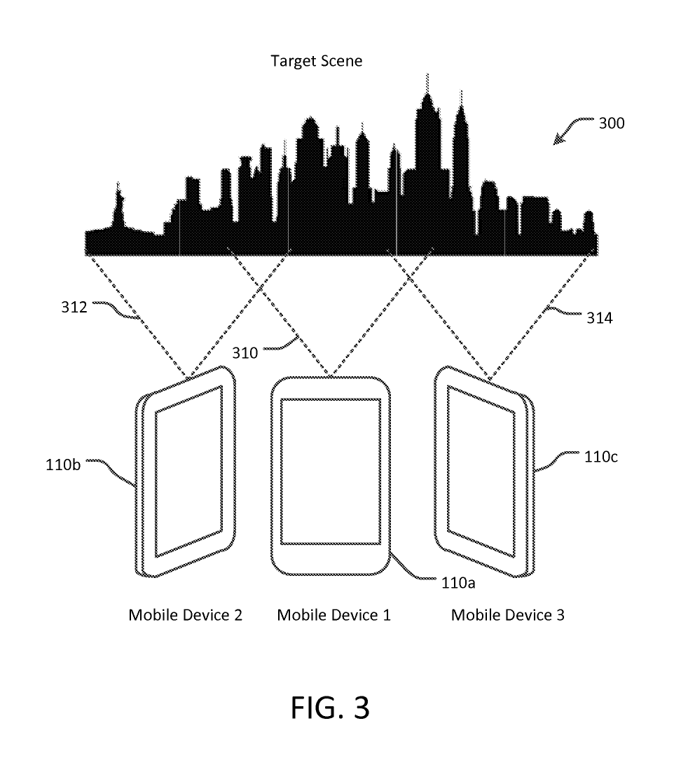

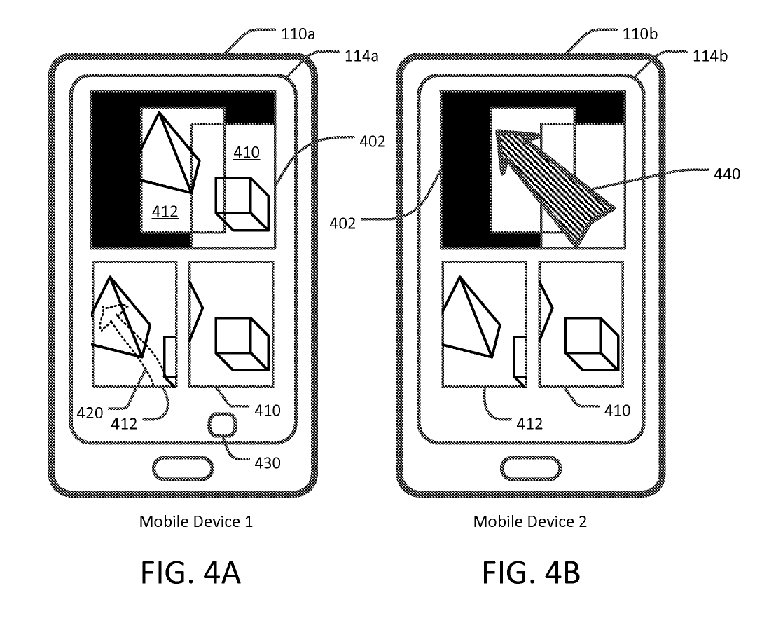

FIG. 2 is an example data flow diagram for the example system 100 of FIG. 1, in accordance with an embodiment. FIG. 2 provides an overview of a data flow generated by an example process, which will be described in further detail below with respect to FIGS. 3, 4A and 4B. Each mobile device 110 further includes a client processing module 116, and the server 120 includes a central processing module 122. The client processing module 116 registers with the central processing module 122 by sending a registration request 202. If the mobile device 110 is the first device in a group, it is the host device. If the mobile device 110 is joining a group including the host device, the registration request 202 includes information encoded in the barcode 116 displayed by the host device. The central processing module 122 returns a registration confirmation 204 to the client processing module 116, which includes a group ID that is encoded in the barcode 116. Subsequent to registration, the client processing module 116 streams viewfinder image data 206 to the central processing module 122. The central processing module 122 stitches the viewfinder image data 206 together with viewfinder image data from other mobile devices 110 and streams panoramic preview data 208 to the client processing module 116. The client processing module 116 uses the panoramic preview data 208 to display a panoramic preview image on the display 114. If the mobile device 110 is a host, the user can cause the client processing module 116 to generate an adjustment request 210 by swiping across the display 114 in the direction the user wishes another user to aim her camera 112. The direction of aim may be, for example, up, down, left, right, or a combination of these (e.g., up and left, down and right, etc.). The adjustment request 210 is relayed as an adjustment command 212 to the other user's device, which uses the adjustment command 212 to display instructions for aiming the camera (e.g., an arrow displayed on the viewfinder indicating the requested direction to adjust the camera aim). Once the panoramic photograph is composed, the host user can cause the client processing module 116 to generate an image capture trigger request 214 to be sent to the central processing module 122, which in turn sends a trigger command 216 to the mobile device 110 for capturing a photograph.

Example Use Case

FIG. 3 shows an example representation of three mobile devices 110a, 110b, 110c configured for synchronized photography, in accordance with an embodiment. Each device 110a, 110b, 110c includes or is otherwise connected to a camera, such as described with respect to FIG. 1. Although for this example three devices are depicted, it will be understood that any number and type of camera-enabled devices can be used. Any one of the devices 110a, 110b, 110c can be designated as a host. In this example, device 110a is the host. Initially, as host, device 110a displays on its screen a barcode or other machine-readable code, such as the QR code 116 depicted in FIG. 1. Each of the other devices 110b, 110c can then scan the barcode displayed on host device 110a to join the same group as device 110a. After scanning, devices 110b, 110c are assigned the same group ID as device 110a, and each device 110a, 110b, 110c displays the same barcode so that other users and devices can join the group by scanning one of the barcodes. In this way a large group can be quickly formed. A server (e.g., the server 120 of FIG. 2) keeps track of which devices (represented, for example, as a unique combination of IP address and port) are associated with the same group ID, and among them which one is the host. When the user of the host device 110a taps an “OK” button on the user interface (UI) to end team formation and enter an image capturing state, a unique section ID is assigned to this group.

In the capturing state, each device 110a, 110b, 110c acquires a viewfinder image of a scene 300, which falls into the fields of view 310, 312 and 314 of each device 110a, 110b, 110c, respectively. These viewfinder images are displayed on the displays of the respective devices, such as shown and described with respect to FIGS. 4A and 4B. As each device 110a, 110b, 110c is manually moved with respect to the scene 300, the fields of view 310, 312, 314 change accordingly. The viewfinder images are not necessarily stored in memory as still photographs or videos, but are displayed while the user composes the desired photograph. As the users are composing the photograph using the viewfinder images, each device 110a, 110b, 110c sends a downscaled version (e.g., having a maximum width or height of 300 pixels) of the current viewfinder image to the server at the rate of approximately three frames per second. The server collects the viewfinder images from all devices 110a, 110b, 110c and generates a coarse panoramic preview image on the fly by stitching the viewfinder images together using a panoramic stitching algorithm. The panoramic preview is then streamed back to each device 110a, 110b, 110c so each user can view the current composition of the scene by all devices before the individual photographs are taken by each camera. Low resolution images may be used for real time communication to reduce network congestion and server processing burden, so as to maintain a smooth user experience.

FIGS. 4A and 4B show example user interfaces of two of the devices of FIG. 3: the host device 110a and one other device 110b, where the group includes at least these two devices. The displays 114a, 114b of each device 110a, 110b include several regions for displaying different images. Region 402 displays the panoramic preview (e.g., a panoramic preview generated from the viewfinder images of each device 110a, 110b and any other devices in the group). Region 410 displays the viewfinder image of device 110a, and region 412 displays the viewfinder image of device 110b. As can be seen, the panoramic preview 402 and the viewfinder images of both devices 110a, 110b are displayed on the screens 114a, 114b of both devices 110a, 110b. In cases where there are more than two devices in the group, the panoramic preview and viewfinder images of some or all of the devices can be displayed on some or all of the devices.

According to an embodiment, the panoramic preview can serve several purposes. For one, it gives each user a direct visualization of how her own scene composition contributes to the final panorama, and in which direction she should move the camera to increase or otherwise change the scene coverage. Without such a preview, it is more difficult for any of the users to observe the panoramic scene prior to taking any photographs. The online preview also turns panorama capturing into a form of a WYSIWYG (what-you-see-is-what-you-get) experience. This is in contrast to prior panorama capturing workflows in which the user is required to finish capturing all the images at first, and then invoke an algorithm to stitch the panorama offline at a later time. However, given that panorama stitching is not a trivial task and involves using advanced computer vision techniques, such prior techniques may fail at times, requiring the user either to repeat the image capturing process. The lack of instant feedback makes this task to be unpredictable. With the live preview according to various embodiments, the user can instantly see how her camera motion affects the final result, and has the opportunity to adjust the camera to avoid or correct any errors or artifacts in the final result, before capturing the actual images. It thus significantly increases the success rate of the system. This is particularly important for collaborative teamwork, since a significant amount of effort may be required for all participating users to accomplish a collaborative session.

In accordance with an embodiment, a version of a panorama stitching algorithm is implemented that uses scale-invariant feature transform (SIFT) matching to estimate affine transforms for aligning the viewfinder images when generating the panoramic preview. Such stitching can be performed when a new viewfinder image is received by the server. The SIFT matching technique extracts feature points from the different viewfinder images and aligns those images based on common feature points. Such stitching may be implemented, for example, using C++ on a server machine with a Core i7 3.2 GHz CPU, which achieves 20 frames per second panorama updating for one panoramic image capture session with up to four devices in the group. Other operations, such as exposure correction, lens distortion correction, and seamless blending can be performed when rendering the final panoramic photograph.

According to various embodiments, there are several techniques for adjusting each of the cameras in the group prior to taking the photographs that include, for example, guided camera adjustment, spontaneous adjustment, instruction-based adjustment, or any combination of these. In an example embodiment, guided camera adjustment can be performed prior to taking a photograph. As mentioned earlier, the users can start a capturing session by pointing their cameras toward roughly the same scene. Then, using the live panorama preview 402, the users individually adjust each their cameras to increase the scene coverage. The adjustments can be made either spontaneously by individual users, or under the guidance of one user (e.g., where one user issues verbal instructions to other users) prior to taking a photograph.

Alternatively, or in addition to, the live panorama preview, additional visualization can be added to the user interface to help users make spontaneous camera adjustment. As shown in FIGS. 4A and 4B, overlaid on the live panorama preview 402 in the upper portion of the UI, each user's camera is visualized within a bounding box that may be uniquely colored (e.g., red, green, blue, etc.). At the lower portion of the UI, each user's viewfinder image 410, 412 is displayed in boxes with corresponding colors. For example, viewfinder image 410 may be bounded by a blue box in both the upper and lower portions of the UI, and likewise viewfinder image 412 may be bounded by a red box in both portions of the UI. Each user is assigned with a unique color, and a user can quickly identify the color associated with her device by looking at the border of the panorama preview 402 in the upper portion to find the corresponding scene coverage in the panorama. It is also possible for the host user to identify the scene coverage of any device by looking at the colors of the bounding boxes. Once a specific user identifies her color, she can then move the camera to increase the scene coverage. The panoramic preview is updated in real-time or near real-time, which permits the user to immediately see the effect of the camera movement to the panoramic preview 402, as well as the relative camera positions 410, 412 of all the devices 110a, 110b. A possible goal of each user is to maximize the coverage of the panorama preview, while maintaining a reasonable amount of scene overlap (e.g., approximately one-fifth of the size of the image) with adjacent cameras to enable the stitching algorithm to stitch the individual photographs together into a panoramic photograph.

Continuing to refer to FIGS. 4A and 4B, according to another example embodiment, instruction-based adjustment can be performed prior to taking a photograph. When performing spontaneous adjustment, different users may start conflicting or duplicating adjustments at the same time. For instance, after initialization, two users may start moving their cameras towards the same direction. After they realize that someone else is doing the same adjustment, they may turn their cameras back at the same time again. As such, a lack of inter-user coordination may make it more difficult to converge all of the cameras to the desired composition. Thus, in accordance with an embodiment, the host user can directly give instructions to other users to guide the overall camera adjustment process. Specifically, when the user of the host device 110a determines that the user of another device 110b is contributing too little to the panorama (e.g., because of too much overlap), she can easily identify the other user's camera in the second row in the interface based on the color of the bounding box 412. The host user can touch the display 114a of the host device 110a in the region of the other device's viewfinder image 412 and swipe in the direction that the host wishes the other user to move her camera (such as indicated at 420). The swipe input 420 causes an adjustment request command (e.g., the adjustment request 210 of FIG. 2) containing the target user and the swiping direction to be sent to the server, which then forwards the request to the other device 110b (e.g., the adjustment command 212 of FIG. 2). Once the adjustment request is received on device 110b, an arrow icon 440 is rendered on the display 114b of device 110b, prompting the user to turn the camera in the suggested direction. The arrow icon 440 can be displayed for a relatively short amount of time before disappearing. If the user of the host device 110a wishes a large movement of the camera of device 110b, the host can swipe multiple times to encourage the user of device 110b to continue the movement until a desired camera orientation is achieved.

According to an example embodiment, once all the devices 110a, 110b, 110c are oriented to obtain the desired panoramic composition, the user of the host device 110a can trigger the photo capturing event by tapping a button 430 on the UI of the host device 110a. In this embodiment, a signal is sent to the server (e.g., the image capture trigger command 214 of FIG. 2), and the server forwards this signal to all the devices in the same group (e.g., the trigger command 216 of FIG. 2). Once a device 110a, 110b, 110c receives the signal, the client processing module automatically triggers the camera to take a photograph, and then uploads the photograph to the server for final panorama stitching. As discussed earlier, allowing all devices to capture simultaneously is useful for taking motion- and artifact-free panoramas in highly dynamic scenes.

Additional Example Use Case

Alice, Bob and Carol all have an application installed on their mobile devices. Carol first opens the application on her device and selects the option of starting a new capturing session, which automatically makes her the host user of the session. A unique QR (quick response) code then appears on her screen. Alice and Bob can scan the QR code on Carol's device using their devices and join the group or capturing session. If Alice scans the code first, the same QR code automatically appears on her screen, so Bob can scan the QR code from either Carol's device or Alice's device.

After all three users join the group, they make a selection on the UI to enter the capturing mode. Initially, they point their cameras to roughly the same direction, so the system can determine their relative camera positions based on the overlapped portions of the images, and then they begin to adjust the camera directions with the help of the interface. On each user's screen, a preview panorama automatically appears, with colored bounding boxes showing the contribution from each camera. Being the host, Carol then guides Alice and Bob to adjust their cameras to increase the scene coverage of the panorama. Carol selects Alice's camera on her screen and swipes to the left. On Alice's screen, she immediately sees a red arrow pointing to the left, indicating that she is instructed to turn her camera that way. She then gradually moves her camera towards the left, and sees that the panorama is updated in real-time according to her camera motion. The red arrow only exists for a short period of time and then disappears. Carol monitors Alice's camera motion on her own screen, and she feels the movement is not enough. So she keeps performing the swipe gesture to instruct Alice to keep moving until her camera is turned into the desired direction.

Similarly, Carol selects Bob's camera and use the swipe gesture to instruct him to turn his camera to the right, which Bob follows. However, Bob moves his camera too far and his image can no longer be stitched with other ones. This is reflected on the panorama preview, and Bob notices this in the panoramic preview on his own screen and moves his camera back. Finally, Carol directly talks to Alice and Bob to move their cameras up a little bit, to capture more on the building and less on the ground.

When Carol feels the current preview panorama is good to capture, she clicks the button to trigger the capture event. Alice and Bob simultaneously see a countdown on their own screen, and they keep their cameras still before the countdown reaches zero. When it happens, all cameras take pictures at the same time. Each device then sends the pictures to the server for stitching into a panoramic photograph.

Example Methodologies

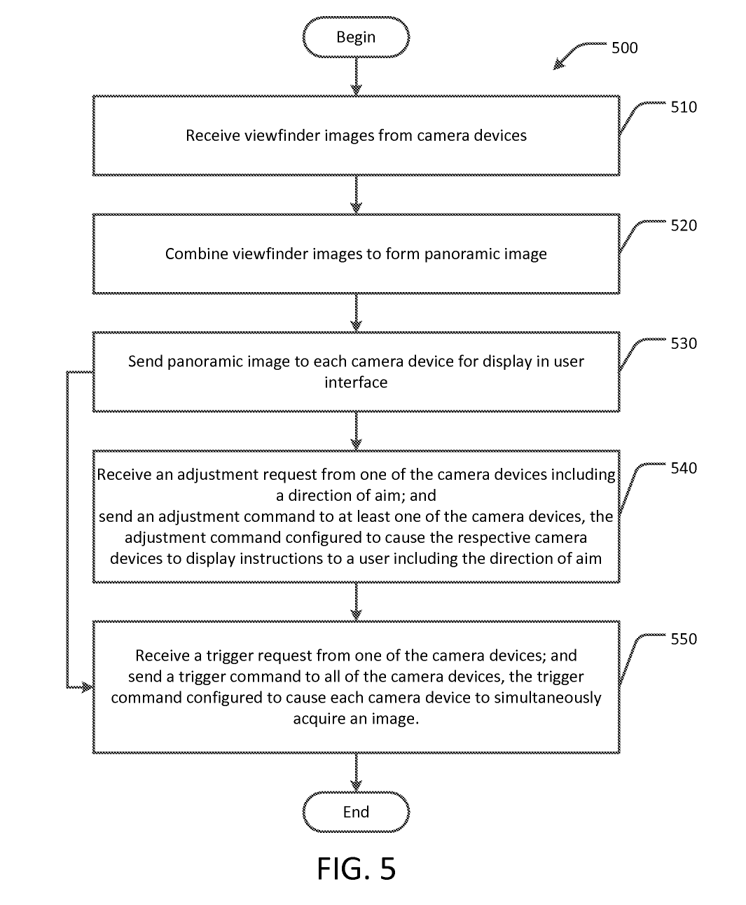

FIG. 5 is a flow diagram of an example methodology 500 for synchronized photography, in accordance with an embodiment. The example methodology 500 may, for example, be implemented by the client processing module 116 of FIG. 2. The method 500 begins by receiving 510 a plurality of viewfinder images from a plurality of different camera devices. At least two of the viewfinder images include an overlapping field of view. The method 500 continues by combining 520 each of the viewfinder images together to form a panoramic image based on the overlapping field of view. The method 500 continues by sending 530 the panoramic image to each of the camera devices for display in a user interface (e.g., in the region 402 of the user interface of FIG. 4A). In some cases, the sending occurs in near real-time with respect to the receiving. In some cases, the method 500 continues by receiving 550 a trigger request from one of the camera devices, and, in response to the trigger request, sending a trigger command to all of the camera devices. The trigger command is configured to cause each camera device to simultaneously acquire an image. In some cases, the method 500 includes receiving 540 an adjustment request from one of the camera devices. The adjustment request includes a direction of aim, such as shown and described with respect to the touch contact input gesture 420 of FIG. 4A. The method 500 further includes, in response to the adjustment request, sending an adjustment command to at least one of the camera devices. The adjustment command is configured to cause the respective camera devices to display instructions to a user including the direction of aim.

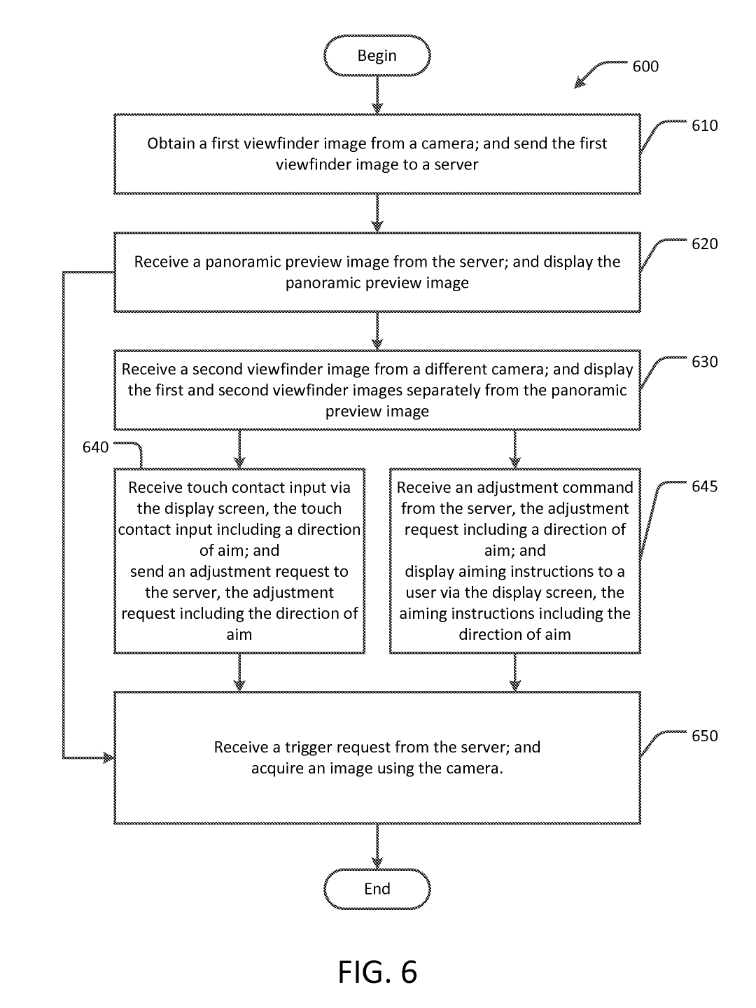

FIG. 6 is a flow diagram of another example methodology 600 for synchronized photography, in accordance with an embodiment. The example methodology 600 may, for example, be implemented by the central processing module 122 of FIG. 2. The method 600 begins by obtaining 610 a first viewfinder image from a camera and sending the first viewfinder image to a server. The method 600 continues by receiving, from the server, a panoramic preview image. The panoramic preview image includes at least a portion of the first viewfinder image in combination with at least a portion of a second viewfinder image from a different camera, such as shown and described with respect to FIG. 4A. The method 600 further includes displaying, via a display screen, the panoramic preview image. In some cases, the method 600 continues by receiving 630, from the server, the second viewfinder image, and displaying, via a display screen, the first and second viewfinder images separately from the panoramic preview image. In some cases, the panoramic preview image changes as each of the first and second viewfinder images change in real-time or near real-time. In some cases, the method 600 continues by receiving 640 a touch contact input via the display screen. The touch contact input includes a direction of aim. The method 600 includes, in response to receiving the touch contact input, sending an adjustment request to the server. The adjustment request includes the direction of aim, such as shown and described with respect to the touch contact input 420 of FIG. 4A. In some other cases, the method 600 includes receiving 645 an adjustment command from the server. The adjustment request includes a direction of aim. The method 600 further includes, in response to receiving the adjustment command, displaying aiming instructions to a user via the display screen. The aiming instructions include the direction of aim, such as shown and described with respect to the arrow icon 440 of FIG. 4B. In some cases, the method 600 continues by receiving 650 a trigger request from the server, and, in response to the trigger request, acquiring an image using the camera.

Example Computing Device

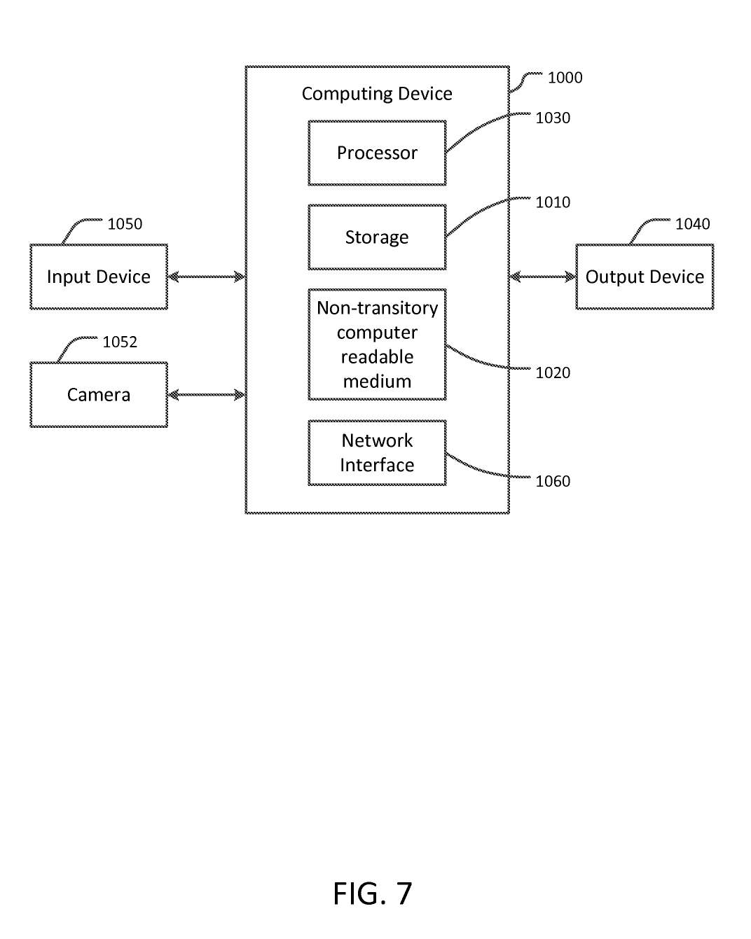

FIG. 7 is a block diagram representing an example computing device 1000 that may be used to perform any of the techniques as variously described in this disclosure. For example, the mobile device 110, the camera 112, the display 114, the client processing module 116, the central processing module 122, or any combination of these may be implemented in the computing device 1000. The computing device 1000 may be any computer system, such as a workstation, desktop computer, server, laptop, handheld computer, tablet computer (e.g., the iPad™ tablet computer), mobile computing or communication device (e.g., the iPhone™ mobile communication device, the Android™ mobile communication device, and the like), or other form of computing or telecommunications device that is capable of communication and that has sufficient processor power and memory capacity to perform the operations described in this disclosure. A distributed computational system may be provided comprising a plurality of such computing devices.

The computing device 1000 includes one or more storage devices 1010 and/or non-transitory computer-readable media 1020 having encoded thereon one or more computer-executable instructions or software for implementing techniques as variously described in this disclosure. The storage devices 1010 may include a computer system memory or random access memory, such as a durable disk storage (which may include any suitable optical or magnetic durable storage device, e.g., RAM, ROM, Flash, USB drive, or other semiconductor-based storage medium), a hard-drive, CD-ROM, or other computer readable media, for storing data and computer-readable instructions and/or software that implement various embodiments as taught in this disclosure. The storage device 1010 may include other types of memory as well, or combinations thereof. The storage device 1010 may be provided on the computing device 1000 or provided separately or remotely from the computing device 1000. The non-transitory computer-readable media 1020 may include, but are not limited to, one or more types of hardware memory, non-transitory tangible media (for example, one or more magnetic storage disks, one or more optical disks, one or more USB flash drives), and the like. The non-transitory computer-readable media 1020 included in the computing device 1000 may store computer-readable and computer-executable instructions or software for implementing various embodiments. The computer-readable media 1020 may be provided on the computing device 1000 or provided separately or remotely from the computing device 1000.

The computing device 1000 also includes at least one processor 1030 for executing computer-readable and computer-executable instructions or software stored in the storage device 1010 and/or non-transitory computer-readable media 1020 and other programs for controlling system hardware. Virtualization may be employed in the computing device 1000 so that infrastructure and resources in the computing device 1000 may be shared dynamically. For example, a virtual machine may be provided to handle a process running on multiple processors so that the process appears to be using only one computing resource rather than multiple computing resources. Multiple virtual machines may also be used with one processor.

A user may interact with the computing device 1000 through an output device 1040, such as a screen or monitor (e.g., the touch-sensitive display 114 of FIG. 1), which may display one or more user interfaces provided in accordance with some embodiments. The output device 1040 may also display other aspects, elements and/or information or data associated with some embodiments. The computing device 1000 may include other I/O devices 1050 for receiving input from a user, for example, a keyboard, a joystick, a game controller, a pointing device (e.g., a mouse, a user's finger interfacing directly with a display device, etc.), or any suitable user interface. The computing device 1000 may include other suitable conventional I/O peripherals, such as a camera 1052. The computing device 1000 can include and/or be operatively coupled to various suitable devices for performing one or more of the functions as variously described in this disclosure.

The computing device 1000 may run any operating system, such as any of the versions of Microsoft® Windows® operating systems, the different releases of the Unix and Linux operating systems, any version of the MacOS® for Macintosh computers, any embedded operating system, any real-time operating system, any open source operating system, any proprietary operating system, any operating systems for mobile computing devices, or any other operating system capable of running on the computing device 1000 and performing the operations described in this disclosure. In an embodiment, the operating system may be run on one or more cloud machine instances.

In other embodiments, the functional components/modules may be implemented with hardware, such as gate level logic (e.g., FPGA) or a purpose-built semiconductor (e.g., ASIC). Still other embodiments may be implemented with a microcontroller having a number of input/output ports for receiving and outputting data, and a number of embedded routines for carrying out the functionality described in this disclosure. In a more general sense, any suitable combination of hardware, software, and firmware can be used, as will be apparent.

As will be appreciated in light of this disclosure, the various modules and components of the system shown in FIG. 1, such as the client processing module 116 and the central processing module 122, can be implemented in software, such as a set of instructions (e.g., C, C++, object-oriented C, JavaScript, Java, BASIC, etc.) encoded on any computer readable medium or computer program product (e.g., hard drive, server, disc, or other suitable non-transient memory or set of memories), that when executed by one or more processors, cause the various methodologies provided in this disclosure to be carried out. It will be appreciated that, in some embodiments, various functions performed by the user computing system, as described in this disclosure, can be performed by similar processors and/or databases in different configurations and arrangements, and that the depicted embodiments are not intended to be limiting. Various components of this example embodiment, including the computing device 100, can be integrated into, for example, one or more desktop or laptop computers, workstations, tablets, smart phones, game consoles, set-top boxes, or other such computing devices. Other componentry and modules typical of a computing system, such as processors (e.g., central processing unit and co-processor, graphics processor, etc.), input devices (e.g., keyboard, mouse, touch pad, touch screen, etc.), and operating system, are not shown but will be readily apparent.

Numerous embodiments will be apparent in light of the present disclosure, and features described in this disclosure can be combined in any number of configurations. One example embodiment provides a system including a storage having at least one memory, and one or more processors each operatively coupled to the storage. The one or more processors are configured to carry out a process including receiving a plurality of viewfinder images from a plurality of different camera devices, at least two of the viewfinder images including an overlapping field of view; combining each of the viewfinder images together to form a panoramic image based on the overlapping field of view; and sending the panoramic image to each of the camera devices for display in a user interface. In some cases, the sending occurs in near real-time with respect to the receiving. In some cases, the process includes receiving a trigger request from one of the camera devices; and, in response to the trigger request, sending a trigger command to all of the camera devices, the trigger command configured to cause each camera device to simultaneously acquire an image. In some cases, the process includes receiving an adjustment request from one of the camera devices, the adjustment request including a direction of aim; and, in response to the adjustment request, sending an adjustment command to at least one of the camera devices, the adjustment command configured to cause the respective camera devices to display instructions to a user including the direction of aim. Another embodiment provides a non-transient computer-readable medium or computer program product having instructions encoded thereon that when executed by one or more processors cause the processor to perform one or more of the functions defined in the present disclosure, such as the methodologies variously described in this paragraph. In some cases, some or all of the functions variously described in this paragraph can be performed in any order and at any time by one or more different processors.

Another example embodiment provides a system including a storage having at least one memory, and one or more processors each operatively coupled to the storage. The one or more processors are configured to carry out a process including obtaining a first viewfinder image from a camera; sending the first viewfinder image to a server; receiving, from the server, a panoramic preview image, the panoramic preview image including at least a portion of the first viewfinder image in combination with at least a portion of a second viewfinder image from a different camera; and displaying, via a display screen, the panoramic preview image. In some cases, the process includes receiving, from the server, the second viewfinder image; and displaying, via a display screen, the first and second viewfinder images separately from the panoramic preview image. In some such cases, the panoramic preview image changes as each of the first and second viewfinder images change in real-time or near real-time. In some cases, the process includes receiving touch contact input via the display screen, the touch contact input including a direction of aim; and, in response to receiving the touch contact input, sending an adjustment request to the server, the adjustment request including the direction of aim. In some cases, the process includes receiving an adjustment command from the different camera, the adjustment request including a direction of aim; and in response to receiving the adjustment command, displaying aiming instructions to a user via the display screen, the aiming instructions including the direction of aim. In some cases, the process includes receiving a trigger request from the server; and in response to the trigger request, acquiring an image using the camera. Another embodiment provides a non-transient computer-readable medium or computer program product having instructions encoded thereon that when executed by one or more processors cause the processor to perform one or more of the functions defined in the present disclosure, such as the methodologies variously described in this paragraph. In some cases, some or all of the functions variously described in this paragraph can be performed in any order and at any time by one or more different processors.

The foregoing description and drawings of various embodiments are presented by way of example only. These examples are not intended to be exhaustive or to limit the invention to the precise forms disclosed. Alterations, modifications, and variations will be apparent in light of this disclosure and are intended to be within the scope of the invention as set forth in the claims.

1. A computer-implemented digital image processing method comprising:
receiving a plurality of viewfinder images from a plurality of different camera devices, at least two of the viewfinder images including an overlapping field of view;
combining, by a processor, each of the viewfinder images together to form a panoramic image based on the overlapping field of view; and
sending the panoramic image to each of the camera devices for display in a user interface.

2. The method of claim 1, wherein the sending occurs in near real-time with respect to the receiving.

3. The method of claim 1, further comprising:
receiving a trigger request from one of the camera devices; and
in response to the trigger request, sending a trigger command to all of the camera devices, the trigger command configured to cause each camera device to simultaneously acquire an image.

4. The method of claim 1, further comprising:
receiving an adjustment request from one of the camera devices, the adjustment request including a direction of aim; and
in response to the adjustment request, sending an adjustment command to at least one of the camera devices, the adjustment command configured to cause the respective camera devices to display instructions to a user including the direction of aim.

5. A computer-implemented digital image processing method comprising:
obtaining a first viewfinder image from a camera;
sending the first viewfinder image to a server;
receiving, from the server, a panoramic preview image, the panoramic preview image including at least a portion of the first viewfinder image in combination with at least a portion of a second viewfinder image from a different camera; and
displaying, via a display screen, the panoramic preview image.

6. The method of claim 5, further comprising:
receiving, from the server, the second viewfinder image; and
displaying, via a display screen, the first and second viewfinder images separately from the panoramic preview image.

7. The method of claim 6, wherein the panoramic preview image changes as each of the first and second viewfinder images change in real-time or near real-time.

8. The method of claim 5, further comprising:
receiving touch contact input via the display screen, the touch contact input including a direction of aim; and
in response to receiving the touch contact input, sending an adjustment request to the server, the adjustment request including the direction of aim.

9. The method of claim 5, further comprising:
receiving an adjustment command from the different camera, the adjustment request including a direction of aim; and
in response to receiving the adjustment command, displaying aiming instructions to a user via the display screen, the aiming instructions including the direction of aim.

10. The method of claim 5, further comprising:
receiving a trigger request from the server; and
in response to the trigger request, acquiring an image using the camera.

11-14. (canceled)

15. A system comprising:
a camera;
a display screen;
a storage; and
a processor operatively coupled to the storage, the camera and the display screen, the processor configured to execute instructions stored in the storage that when executed cause the processor to carry out a process comprising:
obtaining a first viewfinder image from the camera;
sending the first viewfinder image to a server;
receiving, from the server, a panoramic preview image, the panoramic preview image including at least a portion of the first viewfinder image in combination with at least a portion of a second viewfinder image from a different camera; and
displaying, via the display screen, the panoramic preview image.

16. The system of claim 15, wherein the process further comprises:
receiving, from the server, the second viewfinder image; and
displaying, via a display screen, the first and second viewfinder images separately from the panoramic preview image.

17. The system of claim 16, wherein the panoramic preview image changes as each of the first and second viewfinder images change in real-time or near real-time.

18. The system of claim 15, wherein the process further comprises:
receiving touch contact input via the display screen, the touch contact input including a direction of aim; and
in response to receiving the touch contact input, sending an adjustment request to the server, the adjustment request including the direction of aim.

19. The system of claim 15, wherein the process further comprises:
receiving an adjustment command from the different camera, the adjustment request including a direction of aim; and
in response to receiving the adjustment command, displaying aiming instructions to a user via the display screen, the aiming instructions including the direction of aim.

20. The system of claim 15, wherein the process further comprises:
receiving a trigger request from the server; and
in response to the trigger request, acquiring an image using the camera.

21. The system of claim 15, wherein the process further comprises:
receiving a first trigger request from the camera; and
in response to receiving the first trigger request, sending a second trigger request to the server.

22. The system of claim 15, wherein the process further comprises:
receiving a trigger request from the server; and
in response to the trigger request, displaying a countdown sequence that culminates in acquisition of an image.

23. The method of claim 1, further comprising:
receiving a trigger request from one of the camera devices; and
in response to the trigger request, sending a trigger command to all of the camera devices, the trigger command configured to cause each camera device to simultaneously display a countdown sequence that culminates in acquisition of an image.

24. The method of claim 5, further comprising:
receiving a first trigger request from the camera; and
in response to receiving the first trigger request, sending a second trigger request to the server.
